(19) United States
(12) Patent Application Publication
(10) Pub. No.: US 2006/0287462 A1
(43) Pub. Date: Dec. 21, 2006

(54) Process for preparing polyamines having primary amino groups

(76) Inventor: Michael Mager, Leverkusen (DE)

Correspondence Address: BAYER MATERIAL SCIENCE LLC, 100 BAYER ROAD, PITTSBURGH, PA, 15205, US

(21) Appl. No.: 11/451,963

(22) Filed: Jun. 13, 2006

(30) Foreign Application Priority Data
Jun. 17, 2005 (DE) 102005028081.1

(51) Int. Cl. C08G 18/00; C08G 69/08

(52) U.S. Cl. 528/44; 528/310

(57) ABSTRACT

Polyamines having primary amino groups, preferably aromatic amino groups, are prepared in a one-stage process by hydrolyzing compounds containing terminal isocyanate groups. The polyamines produced are useful for preparing polyurethane ureas, which can be used in turn for producing coatings or porous (foams) or non-porous moldings.

### BACKGROUND OF THE INVENTION

The present invention relates to a one-stage process for preparing polyamines having primary amino groups, preferably aromatic amino groups, by hydrolyzing compounds containing terminal isocyanate groups, to polyurethane ureas made from these polyamines and to coatings, porous (foams) and/or non-porous moldings produced from such polyurethane ureas.

The preparation of polyamines having primary amino groups in a one-stage process is disclosed, for example, in EP-A 0 219 035. In this disclosed process, NCO-containing compounds can be broken down in water-containing media, optionally in the presence of catalysts, into polyamines having primary amino groups.

As compared with other prior-art processes, it is possible with the process disclosed in EP-A 0 219 035 to break down virtually all isocyanate(NCO)-functional compounds, including, in particular, NCO-functional prepolymers, into amino-functional compounds (prepolymers) in a relatively uncomplicated way. The catalyst (KOH, for example) is added in such small amounts that it can in principle remain in the product, which in turn represents a considerable simplification as compared to other prior-art processes.

According to the process described in DE-A 2 948 419, large amounts of base have to be used (OH⁻/NCO ratio of at least 1.01:1). Subsequently, in the course of carbamate cleavage by means of strong mineral acids, salts are obtained and must be separated from the amine product, which is costly and inconvenient.

The process described in EP-A 0 219 035, however, has the great disadvantage that the products always contain high proportions of monomeric diamines such as toluenediamine (TDA). In the examples of this disclosed process, the TDA contents found ranged from 0.087% to 0.921%. A further disadvantage of the process described in EP-A 0 219 035. is the high degree of discoloration of the polyamines prepared, a result of the high reaction temperatures during the hydrolysis (typically 90° C.) and during work-up (prolonged distillation at 80 to 100° C.).

As a possible work-up for the reaction mixture of polyamine, water, solvent and catalyst, EP-A 0 219 035 also proposed extraction and employing vacuum distillation or thin-film distillation for the complete separation of catalyst residues from the separated polyamine phase. This multi-stage work-up, embracing extraction and subsequent distillation, however, is very costly and inconvenient, and hence undesirable.

### SUMMARY OF THE INVENTION

It was an object of the present invention to provide a process for preparing polyamines having primary amino groups by hydrolyzing the corresponding polyisocyanates, allowing products to be obtained featuring reduced discoloration and a relatively low proportion of monomeric di- or triamines. It was a further object of the invention to provide products which exhibit a low viscosity, with high conversion of NCO groups into NH₂ groups being achieved at the same time.

It has now been found that gentle and virtually quantitative preparation of such amines is achieved when the hydrolysis is carried out within a specific temperature range and when the separation of the solvent used in the hydrolysis, and of any other volatile constituents, is carried out very gently by continuous distillation.

### DETAILED DESCRIPTION OF THE INVENTION

The present invention accordingly provides a process for preparing polyamines having primary amino groups with a monomeric di- or triaamine fraction of less than 0.1% by weight, in which
A) the free NCO groups of a polyisocyanate prepolymer with an average NCO functionality of at least 1.5 are hydrolyzed with elimination of CO₂
   a1) in the presence of at least 10 parts by weight of a water-soluble or water-miscible solvent for every 100 parts by weight of the polyisocyanate prepolymer used,
   a2) with exposure to water at a molar ratio of water to NCO groups of from 0.75 to 50 and with a weight ratio of solvent to water of from 3 to 200,
   a3) in the presence of from 0.00005% to 1% by weight, based on the weight of prepolymer used, of a catalyst, and
   a4) at a temperature of from 30 to 70° C., and subsequently
B) separating the volatile constituents of the resultant reaction mixture by any of the known continuous distillation methods.

Methods for the preparation of the polyisocyanate prepolymers used in A) are known to those skilled in the art. One suitable method is reaction of at least one polyhydroxy compound with an excess amount of at least one polyisocyanate.

Suitable polyisocyanates include any of the organic aliphatic, cycloaliphatic, -aromatic or heterocyclic polyisocyanates known to those skilled in the art which have at least two isocyanate groups per molecule, and mixtures of such polyisocyanates. Examples of suitable aliphatic and cycloaliphatic polyisocyanates are di- and triisocyanates such as butane diisocyanate, pentane diisocyanate, hexane diisocyanate (hexamethylene diisocyanate, HDI), 4-iso-cyanatomethyl-1,8-octane diisocyanate (triisocyanatononane, TIN) and cyclic systems, such as 4,4′-methylenebis(cyclohexyl isocyanate), 3,5,5-trimethyl-1-isocyanato-3-isocyanatomethylcyclohexane (isophorone diisocyanate, IPDI) and ω,ω′-diisocyanato-1,3-dimethylcyclohexane (H₆XDI). Examples of aromatic polyisocyanates which can be used include 1,5-naphthalene diisocyanate, diisocyanatodiphenylmethane (MDI), crude-MDI, diisocyanatomethylbenzene (2,4- and 2,6-toluene diisocyanate, TDD), particularly the 2,4 and 2,6 isomers and technical mixtures of both isomers, and 1,3-bis(isocyanatomethyl)benzene (XDI). It is preferred, however, to use aromatic diisocyanates. 2,4- and 2,6-toluene diisocyanate (TDI), and also mixtures thereof, and the 2,2′,2,4′ and 4,4′ isomers of diisocyanatodiphenylmethane (MDI), mixtures thereof, and corresponding multinuclear MDI products are particularly preferred.

In addition to this, however, it is also possible to use the conventional derivatives of the aforementioned organic aliphatic, cycloaliphatic, aromatic or heterocyclic polyisocyanates, having a uretdione, allophanate, biuret and/or isocyanurate structure.

As polyhydroxy compounds it is possible to use any of the known compounds having an average OH functionality of at least 1.5.

Examples of suitable polyhydroxy compounds include: low molecular weight diols (e.g., 1,2-ethanediol, 1,3- and 1,2 propanediol, 1,4-butanediol), triols (e.g., glycerol, trimethylolpropane) and tetraols (e.g., pentaerythritol) and also higher molecular weight polyhydroxy compounds such as polyether polyols, polyester polyols, polycarbonate polyols and polythioether polyols.

Preference is given to polyether polyols having number average molecular weights Mₙ of from 300 to 20 000 g/mol, more preferably from 1000 to 12 000 g/mol, most preferably from 2000 to 6000 g/mol.

Such polyether polyols are obtainable in conventional manner by alkoxylating suitable starter molecules under base catalysis or using double metal cyanide compounds (DMC compounds).

Examples of suitable starter molecules for preparing polyether polyols are simple polyols of low molecular weight, water, organic polyamines containing at least two N—H bonds, or any desired mixtures of such starter molecules. Preferred starter molecules for the preparation of polyether polyols by alkoxylation, in particular by the DMC process, are, in particular, simple polyols such as ethylene glycol, propylene-1,3-glycol, butane-1,4,-diol, hexane-1,6-diol, neopentyl glycol, 2-ethylhexane-1,3-diol, glycerol, trimethylolpropane, pentaerythritol and also low molecular weight, hydroxyl-containing esters of such polyols with dicarboxylic acids of the type exemplified below, and low molecular weight ethoxylation or propoxylation products of such simple polyols, and any desired mixtures of such modified or non-modified alcohols. Alkylene oxides suitable for the alkoxylation are, in particular, ethylene oxide and/or propylene oxide, which can be used in any order or as a mixture for the alkoxylation.

Preferred polyether polyols are those described above having an unsaturated end group content of less than or equal to 0.02 milliequivalents per gram of polyol (meq/g), preferably less than or equal to 0.015 meq/g, more preferably less than or equal to 0.01 meq/g (determination method: ASTM D2849-69). Such polyether polyols may be prepared in conventional manner by alkoxylating suitable starter molecules, particularly using double metal cyanide catalysts (DMC catalysis). Suitable methods are described, for example, in U.S. Pat. No. 5,158,922 (e.g., Example 30) and EP-A 0 654 302 (p. 5,1.26 to p. 6,1.32).

In the process of the invention it is possible in principle to use mixtures of two or more polyisocyanates and/or polyhydroxy compounds. However, it is preferred that only one polyisocyanate be used.

The molar ratio of the NCO groups of the polyisocyanate(s) to OH groups of the polyhydroxy compound(s) is typically from 25:1 to 1.5:1, preferably from 15:1 to 1.7:1 and more preferably from 10:1 to 2:1.

The reaction takes place in general at temperatures of from 20 to 140° C., preferably from 40 to 100° C., with or without the use of known polyurethane catalysts, such as tin soaps (dibutyl tin dilaurate, for example) or tertiary amines (triethylamine or diazabicyclooctane (DABCO), for example).

The addition of the components and if possible of a catalyst of the aforementioned kind can in principle take place in any order. Where the polyisocyanate is used in excess, it is preferred to separate it from the reaction mixture after the reaction, by extraction or distillation, preferably by means of thin-film distillation. The removal of excess polyisocyanate is taken to the point that the resultant polyisocyanate prepolymer contains less than 1%, preferably less than 0.5% and more preferably less than 0.1% by weight of residual polyisocyanate.

Suitable polyisocyanate-prepolymers have an NCO content preferably of from 0.5% to 40%, more preferably from 1.2% to 25% and most preferably from 1.5% to 20.5% by weight.

The prepolymers used in A) have NCO functionalities preferably of from 1.5 to 6, more preferably from 1.5 to 4 and most preferably from 2 to 3.

In step a4) of the process of the invention, the hydrolysis temperature range is preferably from 50 to 70° C., more preferably from 60 to 70° C., most preferably from 62 to 68° C.

Solvents used in step a1) of the process of the invention may in principle include all water-soluble or water-miscible amides, lactams, tetraalkylated aliphatic ureas having 4 to 12 carbon atoms, such as tetramethyl urea and tetraethyl urea, aliphatic and cycloaliphatic sulphones or sulphoxides having from 2 to 10 carbon atoms, such as tetramethyl sulphone and dimethyl sulphoxide, and aliphatic and cycloaliphatic phosphoramides such as hexamethylphosphortriamide.

Preferred solvents, however, are water-miscible triamides or lactams. Particularly preferred water-miscible amides are carboxamides such-as aromatic, aliphatic or cycloaliphatic carboxamides having 1 to 10 carbon atoms in the acid moiety. Among the most preferred solvents are dialkyl carboxamides, particularly dimethylformamide (DMF), dimethylacetamide, formamide, diethylformamide, dimethylpropionamide, N,N-dimethylbenzamide and N-methylpyrrolidone.

These solvents may also be used in any desired proportions with respect to one another.

The use of solvents which are not completely miscible with water, such as propionitrile, methyl ethyl ketone, ethyl acetate or hydrocarbons, in addition to a water-soluble or water-miscible solvent is possible in minor amounts, but not preferred.

The fraction of water-soluble or water-miscible solvent used is preferably at least 25 parts by weight, more preferably from 25 to 150 parts by weight, most preferably from 75 to 125 parts by weight, per 100 parts by weight of the polyisocyanate prepolymer employed.

The molar ratio of water to free NCO groups of the polyisocyanate prepolymer is preferably from 1 to 35, more preferably from 1.25 to 12 and most preferably from 1.5 to 7.5.

The weight ratio of solvent to water is preferably from 5 to 150, more preferably from 10 to 100 and most preferably from 25 to 75.

Catalysts used in step a3) of the process of the invention for the hydrolysis reaction can be-basic compounds, containing no NCO-reactive groups, and/or metal compounds. The catalysts used can be solid or liquid but must possess sufficient, and preferably complete, solubility in the reaction mixture.

Examples of basic catalysts of this kind include organic and inorganic salts which produce an alkaline reaction in water. Preferred basic catalyst compounds are: hydroxides of alkali metals and alkaline earth metals, and also tetraalkyl-ammonium hydroxides, such as NaOH and KOH; soluble aluminates such as Na aluminate; carbonates of alkali metals, especially sodium carbonate and potassium carbonate; hydrogen carbonates of alkali metals, especially sodium and potassium hydrogen carbonate; alkali metal and alkaline earth metal salts of monocarboxylic and polycarboxylic acids containing no NCO-reactive groups, preferably salts of aliphatic monocarboxylic acids having up to 18 carbon atoms, such sodium formate, sodium acetate, potassium octoate and potassium stearate; alkali metal salts of phenols and thiophenols optionally substituted by non-NCO-reactive groups; soluble alkali metal and alkaline earth metal salts of weak, preferably inorganic acids such as cyanic acid, isocyanic acid, thiocyanic acid, isothiocyanic acid, silicic acid, phosphorous (III) to (V) acids, hydrocyanic acid, hydrazoic acid; alkali metal mercaptides and sulphides and hydrogen(poly)-sulphides; and β-diketone compounds such as the Na, K, Mg acetylacetonates and acetoacetates.

Other suitable catalysts include tertiary amines, preferably having aliphatic or cycloaliphatic radicals; mixtures of different tertiary amines may also be used. Examples are the trialkylamines which are usually not completely water-soluble, such as trimethyl-amine, triethylamine, tripropylamine, triisopropylamine, dimethyl-n-propylamine, tri-n-butylamine, triisobutylaamine, triisopentylamine, dimethylbutylamine, triamylamine, trioctylhexylamine, dodecyldimethylamine, dimethylcyclo-hexylamine, dibutylcyclohexylamine, dicyclohexylethylamine, tetramethyl-1,3-butanediamine, and also tertiary amines having an araliphatic group, such as dimethylbenzylamine, diethylbenzylarnine, and α-methylbenzyldimethylamine. Trialkylamines having a total of 6 to 15 carbon atoms in all alkyl radicals, such as triethylamine to triamylamine and dimethyl-cyclohexylamine are preferred. Highly suitable tertiary amines, besides the trialkylamines, are amines having an additional tertiary amino group or ether group, particularly in the β-position to the tertiary groups. Examples are dialkylaminoalkyl ethers and bisdialkylaminoalkyl ethers (U.S. Pat. No. 3,330,782; DE-B 1 030 558), such as dimethyl(2-ethoxyethyl)-amine, diethyl(2-methoxy-propyl)amine, bis[2-dimethylaminoethyl]ether, bis[2-diethylaminoethyl]ether, bis[2-diethylamino-isopropyl]ether, 1-ethoxy-2-dimethylamino-ethoxy-ethane, N-methylmorpholine, N-ethylmorpholine, N-butylmorpholine; and also permethylated polyalkylene-diaminees such as tetramethylethylenediamine, tetramethyl-1,2-propylenediamine, pentamethyl-diethylenetriamine, hexa-methyltriethylenetetraamine and higher permethylated homologues (DE-A 2 624 527 and -528); and additionally diethylaminoethyl-piperidine, 1,4-diaza[2.2.2] bicyclooctane, N,N′-dimethylpiperazine, N,N′-diethylpiperazine, N-methyl-N′-dimethylamino-ethylpiperazine, N,N′-bisdimethyl-aminoethylpiperazine, N,N′-bisdimethyl-aminopropylpiperazine and other bisdialkylaminoalkylpiperazines, disclosed in DE-A 2 636 787. The water-soluble compounds in this group such as tetramethylenediamine, permethylated diethylenetriaamine, N-methylmorpholine, bis-2-dimethylaminoethyl ether and N-methylpiperidine are particularly preferred. Acylated tertiary amine derivatives, such as 1-dimethylamino-3-formylamino-propanebenzamide, N-(2-dimethyl-aminoethyl)propionamide, N-(2-diethyl-aminoethyl)benzamide and other tertiary amines containing amide groups (preferably formamide groups) disclosed in DE-A 2 523 633 and 2 732 292 may also be used. Also effective are tertiary amines of the pyridine type and tertiary amines having at least one aromatic radical attached to the nitrogen atom, such as dimethylaniline. Where the tertiary amines are not water-soluble, their boiling point should advantageously be below 250° C., preferably below 200° C. Another group of suitable catalysts includes metal compounds, preferably compounds of tin, zinc or lead, such as dibutyl tin dilaurate, tin octoate, zinc acetylacetonate and lead octoate.

Preferred catalysts, however, are the hydroxides of alkali metals and alkaline earth metals. Particular preference is given to NaOH and KOH.

The catalysts useful in the practice of the present invention are inexpensive, readily available industrially, and where appropriate, can be separated off and used again. In a preferred embodiment of the present invention, the catalyst is allowed to remain in the product.

Basic catalysts can be neutralized where appropriate, in whole or in part by adding acid, which may, for example, facilitate their separation or lessen their activity in the case of any desired subsequent reactions.

The fraction of the catalyst, based on the amount of prepolymer used, is preferably from 0.0001 to 0.099% by weight.

The solids concentration selected for the hydrolysis batch is generally a concentration of less than 90% by weight, preferably from 25% to 75% by weight, more preferably from 40% to 70% by weight. Although lower solids concentrations may be used, for practical reasons (reprocessing of the solvents) they are not preferred.

The process parameters of the present invention make it possible to achieve a conversion of NCO groups into NH₂ groups of at least 90%, preferably at least 92.5%, more preferably at least 95%.

The reaction of the invention is preferably carried out in a homogeneous phase. As a result of slight overdosing of the amount of water or of NCO compound, may result in temporary, slight clouding of the reaction mixture, because the starting materials are no longer fully dissolved.

In some circumstances, it may also be necessary to carry out the reaction under pressure, in order to obtain sufficiently high temperatures.

Continuous distillation in step B) results in polyamines having much less coloration and reduced amounts of monomeric diamines or triamines, than when discontinuous distillation techniques are employed.

Continuous distillation in accordance with the present invention exposes only a portion of the reaction mixture from step A) of the process to an elevated temperature for a short time, while the portion which is not yet within the distillation operation remains at a significantly lower temperature and is supplied continuously to the distillation, while distillate and residue are taken off. An elevated temperature in this context is the temperature for evaporation of the volatile constituents under a selected pressure.

The distillation is preferably carried out at a temperature of less than 100° C., more preferably from 40 to 90° C., most preferably from 60 to 80° C., under pressures of less than 500 mbar, more preferably less than 100 mbar, most preferably from 0.001 to 1.5 mbar.

The temperature of the quantity of prepolymer-containing reaction mixture that is not yet within the distillation operation is preferably from 0 to 60° C., more preferably from 15 to 40° C. and most preferably from 20 to 40° C.

In one preferred embodiment of the invention, the temperature difference between the distillation temperature and the temperature of the quantity of prepolymer-containing reaction mixture that is not yet within the distillation operation is at least 5° C., more preferably at least 15° C., most preferably from 15 to 40° C.

The distillation is preferably conducted at a rate such that the average residence time of the prepolymer-containing reaction mixture for distillation is less than 10 minutes, more preferably less than 5 minutes, at the distillation temperature, and subsequently, by active cooling where appropriate, the mixture is brought to the initial temperature (i.e., temperature prior to distillation) of the prepolymer-containing reaction mixture. The temperature load through which the mixture passes is preferably such that the temperature of the reaction mixture prior to distillation or of the polymer after the distillation, in relation to the distillation temperature employed, is at least 5° C. lower, more preferably at least 15° C. lower, most preferably 15 to 40° C. lower.

Preferred continuous distillation techniques are short-path, falling-film and/or thin-film distillation (Described, for example, in Chemische Technik, Wiley-VCH, Volume 1, 5th edition, pages 333-334).

Falling-film evaporators are composed of a vertical bundle of long tubes in which the liquid to be evaporated is fed in at the top and flows downwards as a film. In the jacket space, heating takes place by means of steam. Within the tubes, vapor bubbles are formed, which flow downwards with the liquid and ensure turbulent conditions. At the bottom end, vapor and liquid separate in a settling vessel.

Thin-film evaporators are apparatus suitable for evaporating temperature-sensitive substances which can be subjected to a thermal load only for a short time. The liquid to be evaporated is fed at the top into a tube with jacket heating. It flows down the tube as a film. Within the tube, a wiper suspended from a shaft rotates and ensures a constant film thickness.

After the conclusion of the process of the invention, the residual amount of solvent(s) and, where appropriate, of other volatile constituents in the polyamine product is less than 2% by weight, preferably less than 1% by weight.

At the same time, the residual amount of monomeric di- or triamine after the process of the invention has been carried out is preferably not more than 0.08% by weight, most preferably not more than 0.05% by weight, based on the polyamine produced.

In one preferred embodiment of the process of the invention, an aromatic diusocyanate is reacted in excess with a polyhydroxy compound at a temperature of from 80 to 120° C. with stirring. Thereafter, the excess dilsocyanate is separated off by means of thin-film distillation, so that the amount of diisocyanate in the polyisocyanate prepolymer formed is less than 0.1% by weight. Thisprepolymer is then hydrolyzed in the initial charge of catalyst (preferably a base such as KOH), solvent (preferably DMF), and water. This reaction is typically conducted at from 50 to 70° C. It is followed by work-up by means of a continuous distillation, such as thin-film distillation, under pressures of less than 5 mbar, preferably less than 1.5 mbar, and temperatures of from 40 to 90° C., preferably from 60 to 80° C.

The preferred aromatic polyamines obtained in accordance with the invention are preferably used, on account of their low vapor pressure, as reaction partners for optionally blocked polyisocyanates or epoxy resins. The polyurethane ureas which result from this can then be used, for example, as a coating-or as porous (foams) or non-porous moldings. To produce coatings, non-porous moldings or foams, the polyamines of the invention can also be combined where appropriate with other compounds of low molecular weight (molecular weight 32 to 399 g/mol) and/or higher molecular weight (molecular weight 400 to 12 000 g/mol) having isocyanate-reactive groups. Particularly suitable in this context are polyhydroxy compounds, which have already been described above in connection with the preparation of the polyisocyanate prepolymer.

To the reactive mixtures composed of (1) the polyamines produced in accordance with the present invention, (2) polyisocyanates, and (3) optional further NCO-reactive compounds and/or polyepoxides it is of course also possible to add the customary auxiliaries and additives such as pigments, (coatings) additives, thixotropic agents, flow control agents, emulsifiers and stabilizers.

The reactive mixtures may be prepared by mixing the components in any order before or during their application, as a coating for example.

The reactive mixtures can be applied to surfaces using conventional techniques such as spraying, dipping, flow coating or pouring. Following evaporative removal of any solvents present, the reactive mixtures which are preferably free of any solvent(s), the coatings then cure under ambient conditions, in particular at minus 20° C. to 40° C., but also at higher temperatures of, for example, 40 to 200° C.

Coatings comprising such polyurethane ureas can be applied for example to metallic surfaces such as iron, steel, aluminum, bronze, brass or chrome. Also possible, however, is the coating of mineral surfaces such as glass, ceramic, stone or concrete, natural materials such as wood, or plastics (e.g., in the form of existing coatings).

Having thus described the invention, the following Examples are given as being illustrative thereof.

### EXAMPLES

Unless indicated otherwise, all percentages in these examples are by weight. The amounts of toluene diisocyanate and toluenediamine were determined by means of HPLC. The figure reported is in each case the sum of the 2,4 and 2,6 isomers. The NCO contents were determined by back-titration of dibutylamine, added in excess, using hydrochloric acid. The NH₂ contents were determined by titration with perchloric acid/glacial acetic acid.

The viscosity measurement took place using a rotational viscometer from Haake at 23° C.

### Comparative Example 1

### a) Preparation of the polyisocyanate-prepolymer

Over the course of 5 hours at a temperature of 80° C., 1027.2 g of a polypropylene glycol (molar weight 2000 g/mol, difunctional, prepared by base-free DMC catalysis) were added with stirring to a mixture of 722.9 g of 2,4-toluene diisocyanate (TDI, Desmodur® T 100, Bayer MaterialScience AG, DE) and 40 mg of 2-chloropropionic acid. After an NCO content of 17.45% had been reached, the reaction mixture was freed from excess TDI by means of thin-film distillation at 140° C. under a pressure <1 mbar.

| | |
|---|---|
| NCO content: | 3.63% |
| Viscosity (23° C.): | 5050 mPas |
| TDI content (free): | 0.03% |

### b) Preparation of the polyamine

Over the course of 80 minutes at a temperature of 95° C., 1000 g of the above-prepared prepolymer were added with stirring to a mixture of 950 g of dimethylformamide (DMF), 0.1 g of KOH and 30 g of water. After a further hour of stirring at 95° C., the volatile constituents were finally separated off by distillation at 95° C. (liquid-phase temperature) under 0.6 mbar. The resulting polyamine had the following characteristics:

| | |
|---|---|
| NH₂ content: | 1.41% |
| Viscosity (23° C.): | 12 110 mPas |
| Solids content: | 99.7% |
| TDA content (free): | 0.24% |

The amount of free toluenediamine (TDA) found was in this case much higher than would have been expected from the TDI content of the prepolymer employed. The hydrolysis at 95° C. and the discontinuous distillation lead to a TDA content of much greater than 0.1% by weight.

### Comparative Example 2

### a) Preparation of the polyisocyanate prepolymer

Preparation took place as in Comparative Example 1, step a). The product obtained had the following characteristics:

| | |
|---|---|
| NCO content: | 3.60% |
| TDI content (free): | 0.01% |

### b) Preparation of the polyamine

Over the course of 80 minutes at a temperature of 65° C., 1010.1 g of the prepolymer prepared as above were added with stirring to a mixture of 959.6 g of dimethylformamide (DMF), 0.1 g of KOH and 30.3 g of water. After a further hour of stirring at 65° C., the volatile constituents were finally separated off by distillation at 65° C. (liquid-phase temperature) under 0.6 inbar. The resulting polyamine had the following characteristics:

| | |
|---|---|
| NH₂ content: | 1.36% |
| Viscosity (23° C.): | 14 690 mPas |
| Solids content: | 99.4% |
| TDA content (free): | 0.19% |

The amount of free toluenediamine (TDA) found was again much higher than would have been expected from the TDI content of the prepolymer employed. Even hydrolysis at a significantly reduced temperature (65° C.) resulted, in the case of the discontinuous distillation employed as before, in a TDA content of much greater than 0.1% by weight.

### Comparative Example 3

### a) Preparation of the polyisocyanate prepolymer

The prepolymer was prepared in the same manner as described in Comparative Example 1 and had the same characteristics of that prepolymer.

### b) Preparation of the polyamine

Over the course of 80 minutes at a temperature of 75° C., 1010.1 g of the above-prepared prepolymer were added with stirring to a mixture of 959.6 g of dimethylformamide (DMF), 0.08 g of KOH and 30.3 g of water. After a further hour of stirring at 65° C., the reaction mixture was cooled to 30° C. and the catalyst was neutralized by adding 0.15 g of phosphoric acid. Finally the volatile constituents were separated off by means of continuous distillation in a thin-film evaporator at 70° C. and 0.5-1.5 mbar. The resulting polyamine had the following characteristics:

| | |
|---|---|
| NH₂ content | 1.35% |
| Viscosity (23° C.): | 10 870 mPas |
| Solids content: | 99.0% |
| TDA content (free): | 0.14% |

The amount of free toluenediamine (TDA) found was again much higher than would had been expected from the TDI content of the prepolymer employed. Even with continuous distillation, the temperature employed for hydrolysis (75° C.) led to a TDA content of significantly greater than 0.1% by weight:

### Example 1

### a) Preparation of the polyisocyanate prepolymer

The prepolymer was prepared by repeating the procedure described in Comparative Example 1, step a). The product obtained had the following characteristics:

| | |
|---|---|
| NCO content: | 3.63% |
| Viscosity (23° C.): | 4880 mPas |
| TDI content (free): | 0.08% |

### b) Preparation of the polyamine

Over the course of 80 minutes at a temperature of 65° C., 1010.1 g of the above-prepared prepolymer were added with stirring to a mixture of 959.6 g of dimethylformamide (DMF), 0.08 g of KOH and 30.3 g of water. After a further hour of stirring at 65° C., the volatile constituents, finally, were separated off by means of continuous distillation in a thin-film evaporator at 70° C. and 0.5-1.5 mbar. The resulting polyamine had the following characteristics:

| | |
|---|---|
| NH₂ content: | 1.35% |
| Viscosity (23° C.): | 11 230 mPas |
| Solids content: | 98.9% |
| TDA content (free): | 0.07% |

With the procedures described, i.e. hydrolysis at 65° C. and continuous distillation at 70° C. in the thin-film evaporator, much lower TDA contents were obtained than by the methods of Comparative Examples 1, 2 and 3.

### Example 2

### a) Preparation of the polyisocyanate prepolymer

The prepolymer was prepared by the same procedure described in Comparative example 1, step a). The product obtained had the following characteristics:

| | |
|---|---|
| NCO content: | 3.62% |
| Viscosity (23° C.): | 4862 mPas |
| TDI content (free): | 0.06% |

### b) Preparation of the polyamine

Over the course of 80 minutes at a temperature of 65° C., 1010.1 g of the above-prepared prepolymer were added with stirring to a mixture of 959.6 g of dimethylformamide (DMF), 0.08 g of KOH and 30.3 g of water. After a further hour of stirring at 65° C., the reaction mixture was cooled to 30° C. and the catalyst was neutralized by adding 0.15 g of phosphoric acid. Finally the volatile constituents were separated off by means of continuous distillation in a thin-film evaporator at 70° C. and 0.5-1.5 mbar. The resulting polyamine had the following characteristics:

| | |
|---|---|
| NH₂ content | 1.34% |
| Viscosity (23° C.): | 14 100 mPas |
| Solids content: | 99.8% |
| TDA content (free): | 0.05% |

With the procedures described, i.e. hydrolysis at 65° C., neutralization of the catalyst and continuous distillation at 65,° C. in the thin-film evaporator, much lower TDA contents were obtained than by the methods of Comparative Examples 1, 2 and 3.

Although the invention has been described in detail in the foregoing for the purpose of illustration, it is to be understood that such detail-is solely for that purpose and that variations can be made therein by those skilled in the art without departing from the spirit and scope of the invention except as it may be limited by the claims.

What is claimed is:

1. A process for the production of a polyamine having (i) primary amino groups and (ii) a monomeric di- or triamine fraction of less than 0.1% by weight comprising:
A) hydrolyzing free isocyanate groups of a polyisocyanate prepolymer with an average isocyanate functionality of at least 1.5 with elimination of CO₂
a1) in the presence of at least 10 parts by weight, per 100 parts by weight of the polyisocyanate prepolymer, of a water-soluble or water-miscible solvent,
a2) in the presence of water in an amount such that a molar ratio of water to isocyanate groups of from 0.75 to 50 and a weight ratio of solvent to water of from 3 to 200 are achieved,
a3) in the presence of from 0.00005% to 1% by weight, based on the amourit of prepolymer used, of a catalyst, and
a4) at a temperature of from 30 to 70° C., and subsequently
B) separating the volatile constituents from the hydrolyzed mixture by a continuous distillation method.

2. The process of claim 1 in that the hydrolysis is carried out at a temperature of from 60 to 70° C.

3. The process of claim 1 in which dimethylformamide, dimethylacetamide, formamide, diethylformamide, dimethylpropionamide, N,N-dimethyl-benzamide, N-methylpyrrolidone or mixtures thereof are used as the solvent.

4. The process of claim 1 in which the molar ratio of water to free isocyanate groups of the polyisocyanate prepolymer is from 1.5 to 7.5.

5. The process of claim 1 in which the weight ratio of solvent to water is from 25 to 75.

6. The process of claim 1 in which a hydroxide of an alkali metal or an alkaline earth metal is used as the catalyst in an amount of from 0.0001 to 0.099% by weight, based on the weight of the prepolymer.

7. The process of claim 1 in which the hydrolysis is continued until the conversion of NCO groups into NH₂ groups is at least 95%.

8. The process of claim 1 in which the continuous distillation is carried out by short-path, falling-film and/or thin-film distillation.

9. The process of claim 1 in which the proportion of monomeric di- or triamine in the polyamine product is not more than 0.08% by weight, based on total weight of the polyamine product.

10. The process of claim 1 in which the temperature during the continuous distillation is below 100° C. under a pressure of less than 500 mbar, the continuous distillation is conducted at a rate such that the average residence time of the hydrolyzed mixture during distillation is less than 10 minutes at this distillation temperature, and the temperature difference between the hydrolyzed mixture prior to distillation and the mixture after distillation in relation to the distillation temperature is at least 15° C.
